(19) United States
(12) Patent Application Publication
(10) Pub. No.: US 2005/0078750 A1
(43) Pub. Date: Apr. 14, 2005

(54) De-blocking filter processing apparatus and de-blocking filter processing method

(75) Inventors: Sheng Mei Shen, Singapore (SG); Men Huang Lee, Singapore (SG); Yoshimasa Honda, Kamakura-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/964,210

(22) Filed: Oct. 14, 2004

(30) Foreign Application Priority Data
Oct. 14, 2003 (JP) 2003-353989

(51) Int. Cl. H04N 7/12

(52) U.S. Cl. 375/240.12; 375/240.24; 375/240.29

(57) ABSTRACT

A de-blocking filter processing apparatus that achieves high picture quality without consuming processing apparatus power unnecessarily. A loop filter 170 used as a de-blocking filter processing apparatus first acquires a variable-size motion estimation block in a frame for which motion estimation processing is performed. Then, de-blocking filter processing is applied adaptively to a frame for which motion estimation processing is performed, in accordance with the acquired motion estimation block. Application of de-blocking filter processing is executed only at a boundary between a particular motion estimation block and a motion estimation block adjacent to that motion estimation block in a frame for which motion estimation processing is performed.

### BACKGROUND OF THE INVENTION

1. Field of the Invention

The present invention relates to a de-blocking filter processing apparatus and de-blocking filter processing method to be used in any advanced multimedia data coding, and more particularly to any video coding using variable block size based motion prediction.

2. Description of Related Art

A variety of filters are generally used in video compression technologies in order to improve picture quality and the compression ratio. Blocky artifacts often occur in images obtained by decoding pictures subjected to low bit-rate video compression due to quantization noise as well as motion compensation. One of the main tasks of a de-blocking filter processing apparatus (hereinafter referred to as “de-blocking filter” or simply “filter”) is to smooth the boundaries of the blocks in the decoded picture so that these blocky artifacts are reduced or removed. A de-blocking filter may be a post filter that achieves high picture quality by removing noise and stabilizing quality when video is reconstructed on the decoder side, or a loop filter that achieves high picture quality by removing noise and improving the compression ratio when video is compressed on the encoder side.

Heretofore, a de-blocking filter for achieving high picture quality has been described in Unexamined Japanese Patent Publication No. 2001-224031. In the above document, a post filter is disclosed wherein filtering strength is applied to a decoded picture according to a coding mode. In addition to this, a loop filter has been proposed that is applied to both reference and non-reference pictures to improve the picture quality of decoded pictures.

However, the above-described conventional filters are applied to pictures on a fixed block size basis.

For example, since, in the video coding related standard ISO/IEC 14496 Part 10, DCT (discrete cosine transform) is conducted on 4×4 size blocks (hereinafter, a block with a size of N×N is referred to as an “N×N block”) a conventional de-blocking filter is designed to be applied to a 4×4 boundary. Also, in the ISO/IEC 14496 Part 2 standard, for example, 8×8 DCT is carried out, and therefore a conventional de-blocking filter is designed to be applied to an 8×8 block boundary. Such filter design is good to take DCT into consideration since DCT is the stage causing most of the blocky noise at a low bit rate.

However, for the interframe wavelet video coding scheme, which has gained a lot of interest lately and may possibly become the future general video coding standard, the above filter design may not be the most appropriate. It typically employs MCTF (Motion Compensated Temporal Filtering), involving block-based motion estimation/compensation, in the temporal direction, and 2D-DWT (Discrete Wavelet Transform) for the spatial transformation. Unlike block-based DCT, DWT does not impose blocky artifacts on decoded pictures. Hence, block-based motion estimation/compensation is the main stage causing blocky artifacts in this scheme. Blocky artifacts are caused, in particular, by inaccurate motion prediction and quantization when motion estimation/compensation is carried out at a low bit rate or in a low delay mode with a small GOP (Group of Pictures) size. In the case of MTCF, this applies to every temporal decomposition level, leading to an accumulation of blocky artifacts over all the temporal decomposition levels.

A description is given below, with reference to FIG. 1, of a general example of wavelet coding using motion estimation (MC wavelet coding). A GOP size of 8 is here taken as an example.

As shown in FIG. 1, there are eight original frames at level 0. After motion estimation and temporal decomposition processing using a temporal direction wavelet filter (a Haar filter is illustrated in this example, but longer filters are also applicable), a group comprising low-pass band frames L1, L2, L3, and L4, and a group comprising high-pass band frames H1, H2, H3, and H4, are produced at level 1. Motion estimation and temporal filter processing are then further performed on low-pass band frames L1, L2, L3, and L4, and at level 2 a group comprising low-pass band frames LL1 and LL2, and a group comprising high-pass band frames LH1 and LH2, are produced. Motion estimation and temporal filter processing are then performed again, and there are finally only two frames, LLL1 and LLH1, at level 3.

Spatial wavelet decomposition is then performed on frames LLL1 and LLH1 at level 3, LH1 and LH2 at level 2, and H1, H2, H3, and H4 at level 1, after which scanning is carried out, followed by entropy coding (variable-length coding) taking spatial, temporal, and quality scalability into consideration, to produce a scalable stream.

As is generally understood, motion estimation used in wavelet coding is not always based on a fixed block size, such as 16×16 in ISO/IEC 13818 Part 2, or a maximum of 16×16 in ISO/IEC 14496 Part 2. This size can vary from as small as 4×4 to as large as 64×64 or more depending on the nature of the video. FIG. 2A and FIG. 2B show examples of variable block sizes (from 4×4 to 64×64, for example) that can be used in block matching for motion estimation/compensation between reference frame A and current frame B.

FIG. 3 shows an example of the application of fixed block size based de-blocking filter processing in the prior art. Here, an example is described in which the de-blocking filter processing indicated by dotted lines is applied to a frame that has the blocks indicated by solid lines. Blocks S1, S2, and S3 have sizes selected for motion estimation, block S1 being a 64×64 block, block S2 a 32×32 block, and block S3 a 16×16 block.

If the block size of motion estimation is assumed to be 64—64 as in the case of block S1, there should be no blocky artifact inside the block. In such a case, if de-blocking filter processing with a fixed size that is smaller than 64—64 is applied, processing apparatus (for example, CPU) power will be consumed unnecessarily. Not only that, but important information will be filtered, as a result of which image sharpness will be lost and the image will be blurred, and in the final analysis, it will not be possible to achieve high picture quality.

### SUMMARY OF THE INVENTION

It is an object of the present invention to provide a de-blocking filter processing apparatus and de-blocking filter processing method that enable high picture quality to be achieved without consuming processing apparatus power unnecessarily.

The present invention achieves the above object by applying de-blocking filter processing to a frame for which motion estimation is performed in accordance with a variable-size motion estimation block in that frame.

According to an aspect of the invention, a de-blocking filter processing apparatus has an acquisition section that acquires a variable-size motion estimation block in a frame for which motion estimation processing is performed, and an application section that applies de-blocking filter processing to the aforementioned frame in accordance with the acquired motion estimation block.

According to another aspect of the invention, a de-blocking filter processing method has an acquisition step of acquiring a variable-size motion estimation block in a frame for which motion estimation processing is performed, and an application step of applying de-blocking filter processing to the aforementioned frame in accordance with the acquired motion estimation block.

### BRIEF DESCRIPTION OF THE DRAWINGS

The above and other objects and features of the invention will appear more fully hereinafter from a consideration of the following description taken in conjunction with the accompanying drawings wherein examples are illustrated by way of example, in which:

FIG. 1 is a drawing showing a general example of MC wavelet coding of the prior art;

FIG. 2A is a drawing showing an example of variable block sizes for motion estimation/compensation of the prior art, and is a drawing showing a reference frame;

FIG. 2B is a drawing showing an example of variable block sizes for motion estimation/compensation of the prior art, and is a drawing showing a current frame;

FIG. 3 is a drawing showing an application example of fixed block size based de-blocking filter processing of the prior art;

FIG. 4 is a block diagram showing the configuration of a video coding apparatus that has a loop filter according to Embodiment 1 of the present invention;

FIG. 5 is a flowchart for explaining the operation of de-blocking filter processing executed by a loop filter according to Embodiment 1 of the present invention;

FIG. 6 is a drawing showing an application example of variable block size based de-blocking filter processing according to Embodiment 1 of the present invention;

FIG. 7 is a drawing for explaining an example of tap length setting in de-blocking filter processing according to Embodiment 1 of the present invention;

FIG. 8 is a drawing for explaining another example of tap length setting in de-blocking filter processing according to Embodiment 1 of the present invention;

FIG. 9 is a drawing showing the relationship between de-blocking filter processing and temporal decomposition levels according to Embodiment 1 of the present invention;

FIG. 10 is a block diagram showing the configuration of a video decoding apparatus that has a loop filter according to Embodiment 2 of the present invention; and

FIG. 11 is a block diagram showing the configuration of a video decoding apparatus that has a post filter according to Embodiment 3 of the present invention.

### DESCRIPTION OF THE PREFERRED EMBODIMENTS

With reference now to the accompanying drawings, embodiments of the present invention will be explained in detail below.

### Embodiment 1

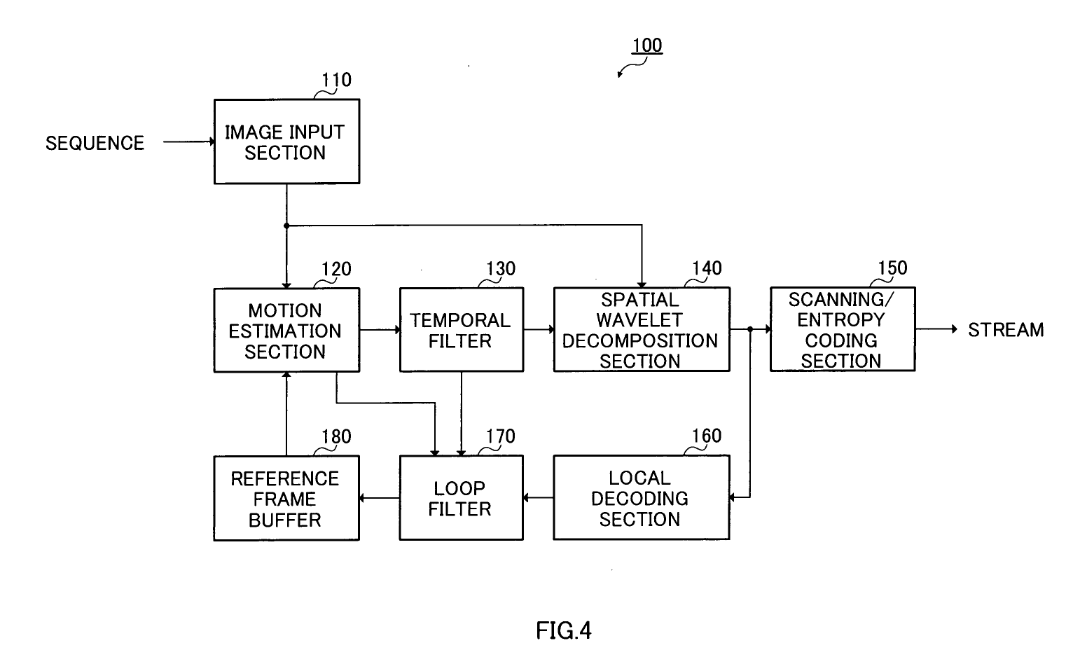

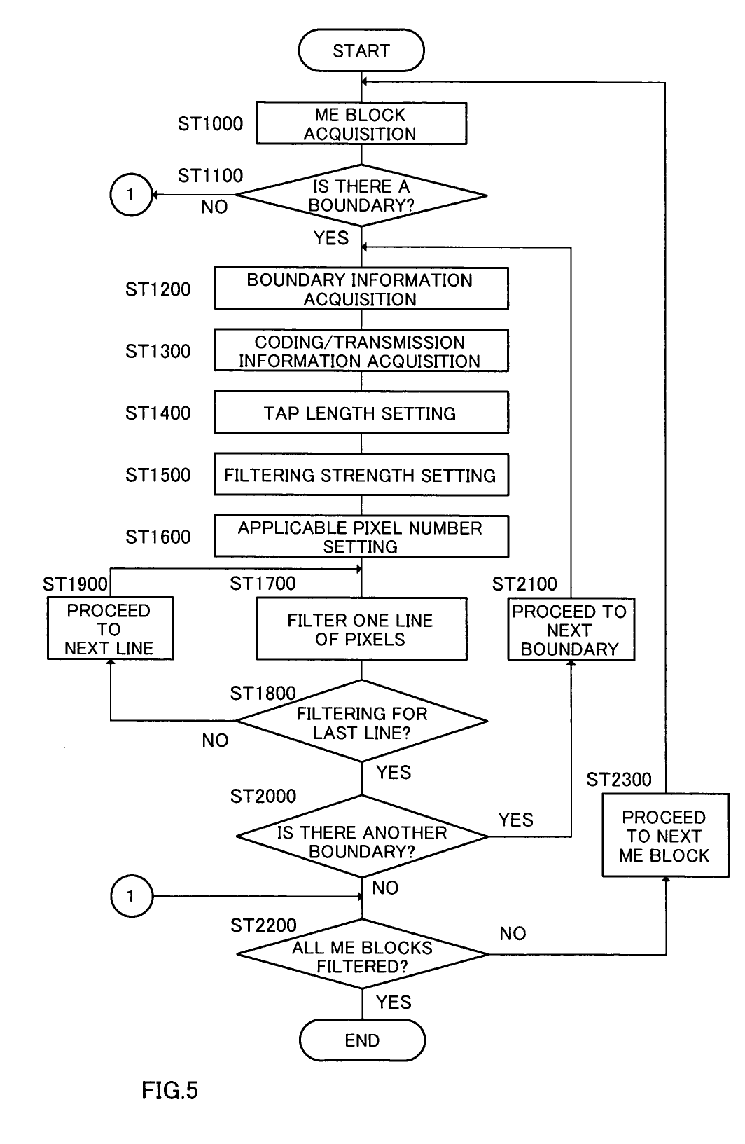

FIG. 4 is a block diagram showing the configuration of a video coding apparatus that has a loop filter according to Embodiment 1 of the present invention.

Video coding apparatus 100 shown in FIG. 4 has an image input section 110, motion estimation section 120, temporal filter 130, spatial wavelet decomposition section 140, scanning/entropy coding section 150, local decoding section 160, loop filter 170, and reference frame buffer 180.

Image input section 110 groups a predetermined number (fixed number or variable number) of neighboring frames in an input video sequence as one GOP, and then outputs the frames to motion estimation section 120. Image input section 110 may also output a frame directly to spatial wavelet decomposition section 140 in order to obtain a coded frame independently of other frames for the purpose of random access or error recovery, for example.

Motion estimation section 120 references a reference frame temporarily stored in reference frame buffer 180, and performs motion estimation and motion compensation on frames from image input section 110 within the same GOP or among a plurality of GOPs.

Temporal filter 130 performs temporal wavelet decomposition on the motion compensated frames, and generates low-band and high-band temporal frames at a plurality of temporal decomposition levels.

Spatial wavelet decomposition section 140 performs spatial wavelet decomposition on temporal frames from temporal filter 130 or frames from image input section 110.

Scanning/entropy coding section 150 performs scanning and entropy coding on frames from spatial wavelet decomposition section 140. Frames that have been thus processed are output as a scalable coded bit stream.

Local decoding section 160 performs local decoding of frames output from spatial wavelet decomposition section 140.

Loop filter 170, which is a characteristic part of the present invention, performs de-blocking filter processing described later herein on locally decoded frames, excluding independent coded frames. De-blocking filter processing is executed for each of a plurality of temporal decomposition levels. When executing de-blocking filter processing, loop filter 170 acquires coding/transmission information in order to execute de-blocking filter processing adaptively. The acquired coding/transmission information includes motion estimation information relating to motion estimation by motion estimation section 120 and temporal decomposition information relating to temporal wavelet decomposition by temporal filter 130, as well as the quantization parameter, bit rate related information, color components, the required spatial resolution, the required temporal resolution, and so forth. Motion estimation information includes such information as, for example, ME (motion estimation) block size, motion prediction mode (intra (intra-frame predictive coding) mode, forward predictive coding mode, backward predictive coding mode, or bi-directional predictive coding mode), motion vector information, and scene changes information. Temporal decomposition information includes information such as, for example, the decomposition filter used, the temporal decomposition level of the object of processing, and the GOP size.

Reference frame buffer 180 temporarily stores frames that have undergone de-blocking filter processing by loop filter 170 as reference frames used in motion estimation by motion estimation section 120.

Next, de-blocking filter processing executed by loop filter 170 of video coding apparatus 100 that has the above-described configuration will be described. FIG. 5 is a flowchart for explaining the operation of de-blocking filter processing executed by the loop filter. The de-blocking filter processing described here is executed on frames subject to processing at each temporal decomposition level (for example, in order from the first temporal decomposition level to the last temporal decomposition level). This processing is executed on low-band frames of each temporal decomposition level, for example.

De-blocking filter processing is started from ME block acquisition in step S1000. Here, one of the ME blocks making up a temporal frame is selected and acquired.

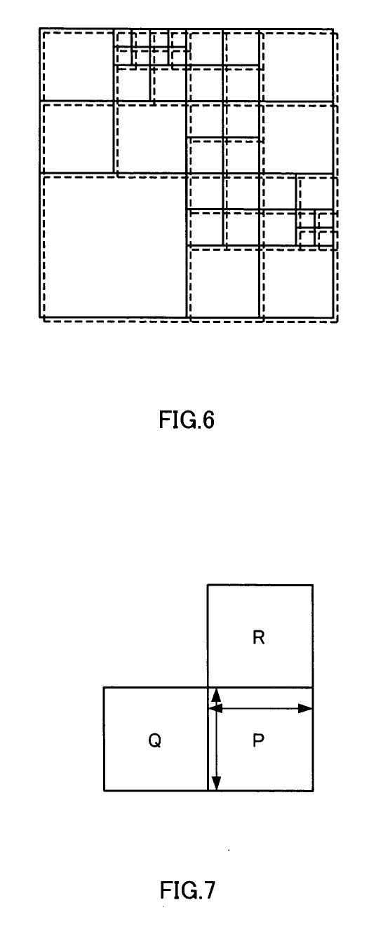

That is to say, in this step, ME blocks used in motion estimation/compensation are acquired one at a time. By so doing, the filter size (tap length described later herein) for de-blocking filter processing can be adapted to variable block sizes of ME blocks. FIG. 6 is a drawing showing an application example of variable block size based de-blocking filter processing. In FIG. 6, it can be seen that de-blocking filter processing filter sizes indicated by dotted lines are matched to variable block size ME blocks indicated by solid lines.

Then, in step S1100, it is determined whether or not another block is adjacent to an ME block on at least one of its top side and left side—that is, whether or not there is at least one of a top horizontal boundary and left vertical boundary. If it is determined that there is an above-described boundary (S1100: YES), the processing flow proceeds to step S1200, and if it is determined that there is no above-described boundary (S1100: NO), the processing flow proceeds to step S2200.

In step S1200, one of the boundaries of the acquired ME block is selected and acquired. Then, in step S1300, the above-described coding/transmission information is acquired.

Next, in step S1400, the tap length of de-blocking filter processing to be applied to the ME block and adjacent block for noise removal is set. The tap length is determined by adopting the smaller of the dimensions of two adjacent blocks. In the case of de-blocking filter processing applied to a horizontal boundary (vertical filter processing), the tap length is determined depending on the block height, and in the case of de-blocking filter processing applied to a vertical boundary (horizontal filter processing), the tap length is determined depending on the block width.

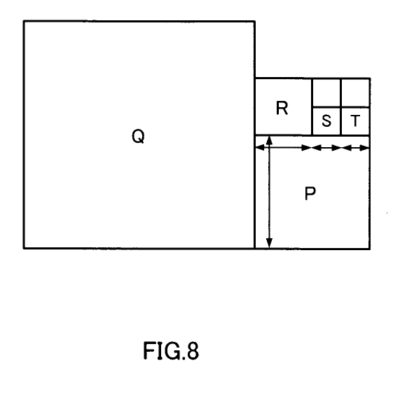

FIG. 7 and FIG. 8 are drawings for explaining examples of tap length setting in de-blocking filter processing.

In the example shown in FIG. 7, processing target block P, block R adjacent to the top of block P, and block Q adjacent to the left side of block P, are all of the same size. In this case, the tap length of horizontal filter processing applied to block P is determined based on the height of blocks P and Q, and the tap length of vertical filter processing applied to block P is determined based on the width of blocks P and R.

In the example shown in FIG. 8, on the other hand, the dimension of processing target block P is smaller than that of block Q adjacent to the left side of block P, and is larger than the dimensions of blocks R, S, and T adjacent to the top of block P. In this case, the tap length of horizontal filter processing applied to block P is determined based on the height of block P. Also, of the vertical filter processing applied to block P, the tap length of the one corresponding to the boundary with block R is determined based on the width of block R. Furthermore, of the vertical filter processing applied to block P, the tap length of the one corresponding to the boundary with block S is determined based on the width of block S, and of the vertical filter processing applied to block P, the tap length of that corresponding to the boundary with block T is determined based on the width of block T.

Thus, the larger the area in which noise is generated, the larger is the tap length setting that is possible without waste.

Then, in step S1500, the filtering strength to be used when applying de-blocking filter processing is set. Filtering strength is set according to the motion prediction modes of two adjacent blocks so that de-blocking filter processing of greater filtering strength is applied to the block with strong noise intensity. For example, if four levels of filtering strength can be set, filtering strength setting is carried out as follows. If the motion prediction mode of either one or both of the two blocks is intra, the strongest filtering strength (Bs=3) will be set. If both blocks reference different reference frames, if both blocks reference different numbers of reference frames, or if both blocks reference the same reference frames but their motion vectors are not similar, the second strongest filtering strength (Bs=2) will be used. If both blocks reference the same reference frames and their motion vectors are similar, the third strongest (second weakest) filtering strength (Bs=1) will be used. In other cases, filtering strength is set to be turned off (Bs=0), and filtering is not applied to the corresponding boundary.

Next, in step S1600, the number of pixels to which de-blocking filter processing is to be applied is set. More specifically, the number of target pixels in horizontal filter processing applied to a vertical boundary is set by determining how many pixels to which horizontal filter processing is to be applied on the respective sides, i.e. left and right sides, of the vertical boundary. Also, the number of target pixels in vertical filter processing applied to a horizontal boundary is set by determining how many pixels to which vertical filter processing is to be applied on the respective sides, i.e. upper and lower sides, of the horizontal boundary.

In the case of a vertical boundary, different values may be set for the number of target pixels on the left and right of the boundary, and in the case of a horizontal boundary, different values may be set for the number of target pixels above and below the boundary. However, from the standpoint of improving processing efficiency and processing speed, it is more effective to set the same value for the number of target pixels on the left and right of the boundary, or for the number of target pixels above and below the boundary.

A threshold value is used for determining which pixels to filter and how many pixels to filter. This threshold value corresponds to the amount of filtering required to correct the block noise introduced during the encoding process or transmission process due to layered data dropping for scalability. Threshold values could be set empirically depending on the coding scheme used.

The threshold value is determined based on the quantization parameter and temporal decomposition level of the frame undergoing filtering. Different quantization parameters will possibly produce block noise of different characteristics and magnitude. If the quantization parameter is not explicitly specified in the coding scheme, it can be derived from the required bit rate or the number of bit planes truncated from the bit stream. For example, a lower bit rate or a greater number of bit planes truncated can be supposed to apply a larger quantization parameter. Due to the normalization of frame pixels during the MTCF process, the dynamic range of pixel values changes at each temporal decomposition level, and the threshold value may also be determined by this dynamic range.

Then, in steps S1700, S1800, and S1900, based on the filter type, filtering strength, and number of pixels to filter, filtering is performed on every line of pixels at the acquired boundary. More specifically, in step S1700 one line of pixels is filtered, and in step S1800 it is determined whether or not filtering has been completed for the last line (whether or not there are any remaining lines at the acquired boundary). If it is determined that filtering has not been completed for the last line (S1800: NO), processing proceeds to the next line in step S1900, and the processing flow returns to step S1700. If, on the other hand, it is determined that filtering has been completed for the last line (S1800: YES), the processing flow proceeds to step S2000.

In step S2000 it is determined whether or not the acquired ME block has an as yet unfiltered boundary other than the previously acquired boundary. If it is determined that another boundary remains (S2000: YES), processing proceeds to the next boundary in step S2100, and the processing flow returns to step S1200. If, on the other hand, it is determined that no other boundary remains (S2000: NO), the processing flow proceeds to step S2200. Performing this kind of determination enables filtering to be applied to all blocks in motion estimation/compensation processing. This de-blocking filter processing can therefore be applied to various reconstructed frames including temporal frames at each temporal decomposition level.

In step S2200 it is determined whether or not there is an as yet unfiltered ME block other than the previously acquired ME block—in other words, whether or not all the ME blocks have been filtered—in the temporal frame currently being processed. If it is determined that another ME block remains (S2200: NO), processing proceeds to the next ME block in step S2300, and the processing flow returns to step S1000. If, on the other hand, it is determined that no other ME block remains (S2200: YES), de-blocking filter processing at the current temporal decomposition level is terminated.

By performing the above-described de-blocking filter processing, it is possible to carry out motion estimation for the following frames and at the next temporal decomposition level using clearer reference frames.

In de-blocking filter processing, apart from the above-described processes, execution of de-blocking filter processing may be switched on and off automatically in accordance with acquired color component information.

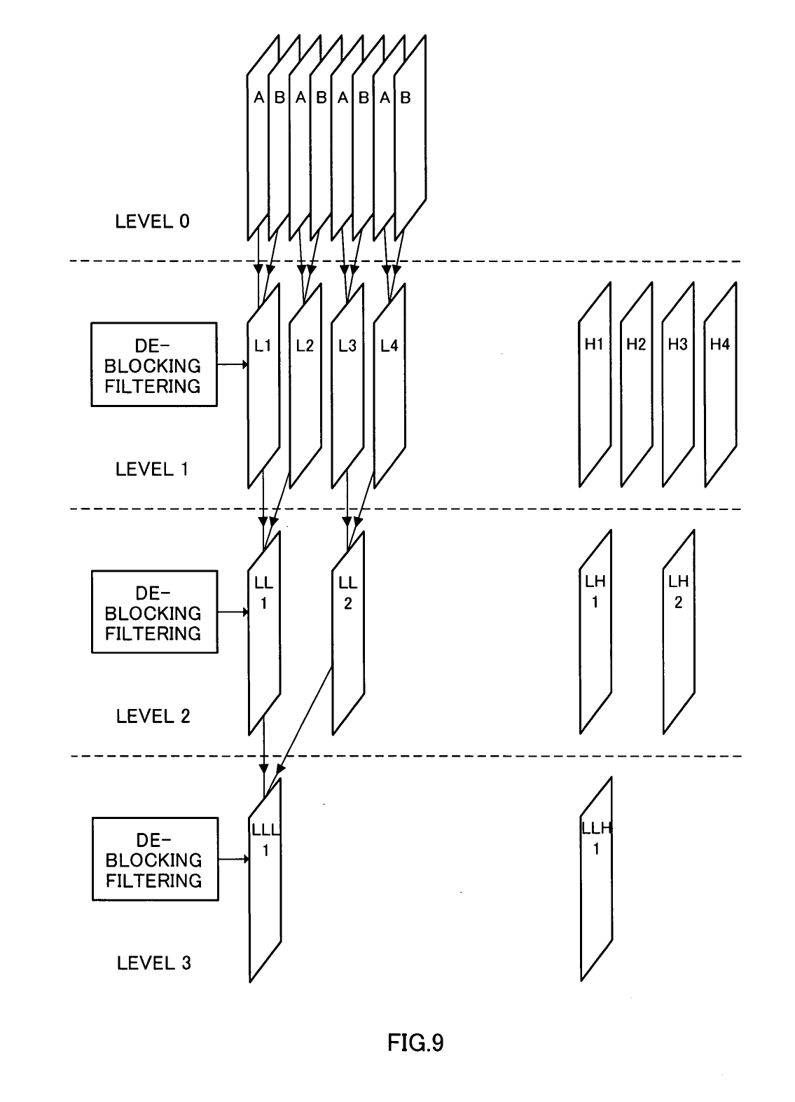

As already stated, de-blocking filter processing executed by loop filter 170 corresponds to each temporal decomposition level. That is to say, if eight original frames at level 0 are temporally decomposed into temporal frames from level 1 to level 3, as shown in FIG. 9, the above-described de-blocking filter processing is executed at each of levels 1, 2, and 3.

Thus, according to this embodiment, de-blocking filter processing is performed only at a boundary between a motion estimation block in a frame on which motion estimation processing is executed and another motion estimation block adjacent to that motion estimation block in accordance with variable-size motion estimation blocks, so that the de-blocking filter processing filter size and motion estimation block size can be made to match, an increase in the amount of de-blocking filter processing can be suppressed and unnecessary loss of picture sharpness prevented, and high picture quality can be achieved without consuming processing apparatus power unnecessarily.

### Embodiment 2

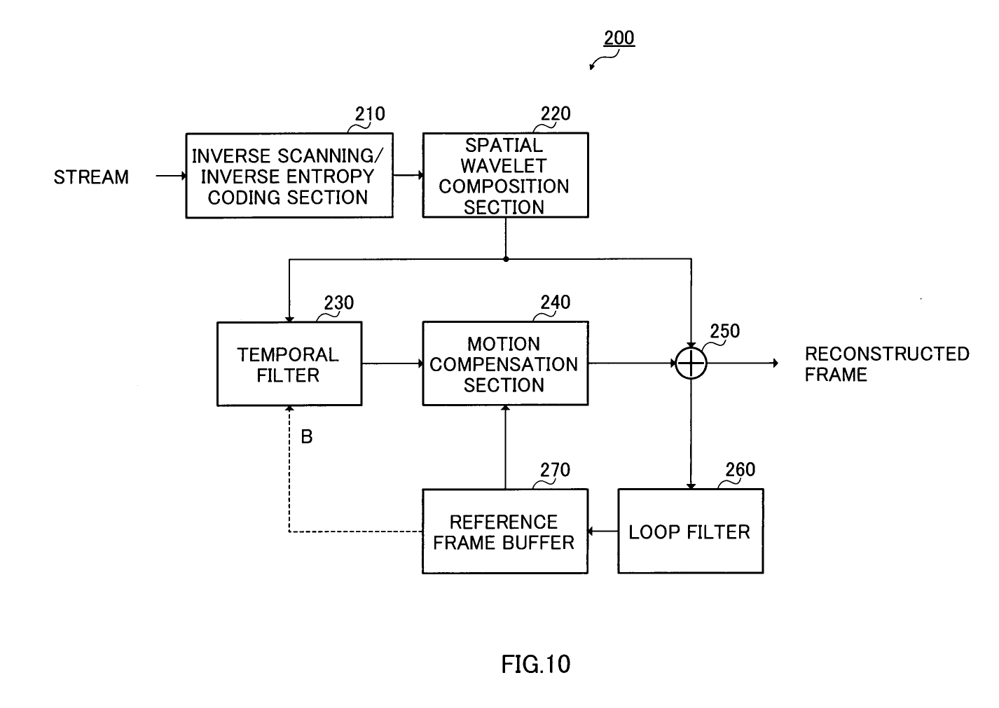

FIG. 10 is a block diagram showing the configuration of a video decoding apparatus that has a loop filter according to Embodiment 2 of the present invention.

In this embodiment, a general case is described in which a filter that executes de-blocking filter processing according to the present invention is used on both the encoder side and the decoder side. The encoder-side filter is similar to loop filter 170 described in Embodiment 1, and therefore a description thereof is omitted here.

Video decoding apparatus 200 shown in FIG. 10 has an inverse scanning/inverse entropy coding section 210 that performs inverse scanning and inverse entropy coding on a stream input from a corresponding video coding apparatus, a spatial wavelet composition section 220 that performs spatial wavelet composition on generated frames, a temporal filter 230 that performs temporal filter processing on frames other than independent coded frames, a motion compensation section 240 that performs motion compensation on frames that have undergone temporal filter processing (temporal wavelet composition), a picture addition section 250 that adds motion compensated frames and generates reconstructed frames or generates reconstructed frames from independent coded frames, and outputs the generated reconstructed frames, a loop filter 260 that executes processing of the same kind as the de-blocking filter processing executed by loop filter 170 described in Embodiment 1, anda reference frame buffer 270 that temporarily stores frames that have undergone de-blocking filter processing by loop filter 260 as reference frames used in motion compensation by motion compensation section 240.

Dotted-line arrow B in FIG. 10 indicates that processing in accordance with a plurality of temporal decomposition levels is performed within video decoding apparatus 200.

Loop filter 260 can execute the processing similar to the de-blocking filter processing described in detail in Embodiment 1 by separating and acquiring from a stream coding/transmission information for executing de-blocking filter processing adaptively, and thus enables clearer reference frames to be used in temporal wavelet composition by temporal filter 230 and motion compensation by motion compensation section 240.

Also, loop filter 260 can change the temporal decomposition level at which de-blocking filter processing is applied from a single temporal decomposition level to a plurality of temporal decomposition levels adaptively in accordance with signaling from a corresponding video coding apparatus by separating that signaling from a stream and receiving that signaling. Thus, when a predetermined directive is transmitted from the corresponding video coding apparatus, the temporal decomposition level or number thereof at which de-blocking filter processing is applied can be reduced, and it is possible to improve the processing efficiency and reduce the processing load of video decoding apparatus 200.

Thus, according to this embodiment, the same kind of operational effect as from the loop filter in the video coding apparatus described in Embodiment 1 can be realized by a loop filter in a video decoding apparatus. Also, as coding/transmission information is acquired by being separated from a stream from a corresponding video coding apparatus, the de-blocking filter processing executed by a video coding apparatus and video decoding apparatus can be made similar, and the loop filters in the respective apparatuses can be operated as a pair.

In this embodiment, coding/transmission information has been described as being acquired from a stream from a video coding apparatus, but this is not a limitation if it is possible for video decoding apparatus 200 to derive coding/transmission information on its own.

### Embodiment 3

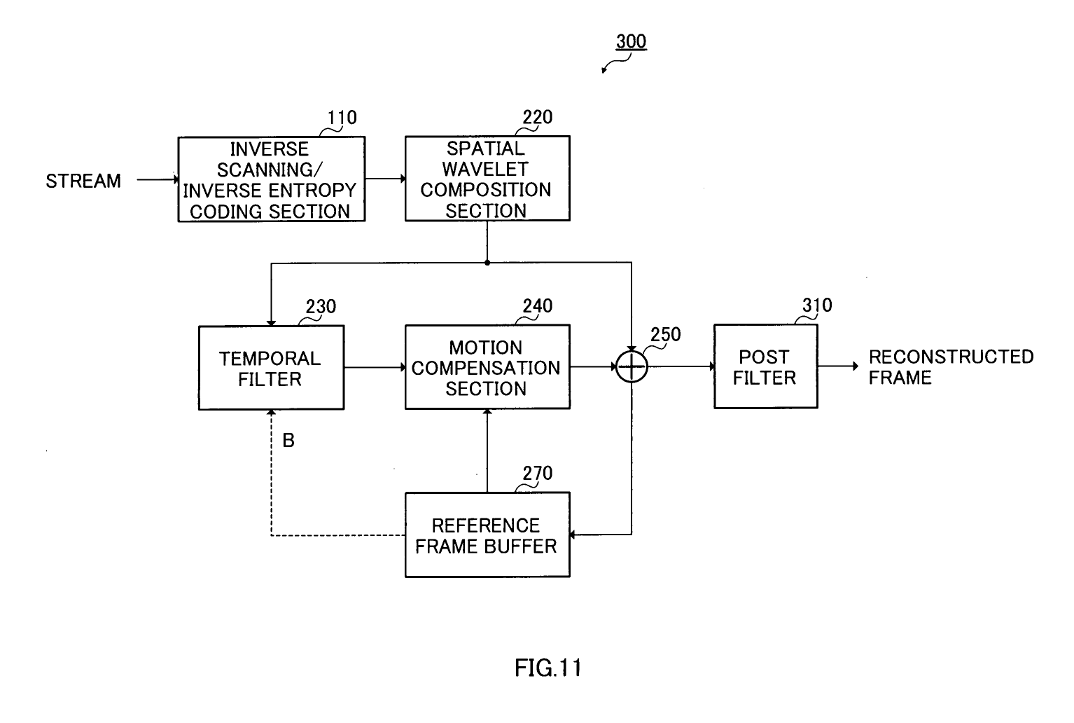

FIG. 11 is a block diagram showing the configuration of a video decoding apparatus that has a post filter according to Embodiment 3 of the present invention. The video decoding apparatus of this embodiment has a similar basic configuration to that of video decoding apparatus 200 described in Embodiment 2, and therefore identical configuration elements are assigned the same reference codes and detailed descriptions thereof are omitted.

In this embodiment, a general case is described in which a filter that executes de-blocking filter processing according to the present invention is used only on the decoder side.

Video decoding apparatus 300 shown in FIG. 11 has a configuration in which a post filter 310 is provided instead of loop filter 260 in video decoding apparatus 200 shown in FIG. 10.

Post filter 310 applies a processing similar to the de-blocking filter processing described in detail in Embodiment 1 to reconstructed frames from picture addition section 250, and outputs clearer frames on which de-blocking filter processing has been performed as reconstructed frames.

Post filter 310 can execute the processing similar to the de-blocking filter processing described in detail in Embodiment 1 by separating and acquiring from an input stream coding/transmission information for executing de-blocking filter processing adaptively. However, the acquisition from a stream need not be performed if it is possible for video decoding apparatus 300 to derive coding/transmission information on its own.

The de-blocking filter processing executed by post filter 310 is implemented by executing de-blocking filter processing executed by loop filter 260 described in Embodiment 2 at the last level when reconstructed frames are generated.

Thus, according to this embodiment, the same kind of operational effect as from the loop filter in the video coding apparatus described in Embodiment 1 can be realized by a post filter in a video decoding apparatus.

As described above, according to the present invention, high picture quality can be achieved without consuming processing apparatus power unnecessarily.

A de-blocking filter processing apparatus and de-blocking filter processing method of the present invention have the effect of achieving high picture quality without consuming processing apparatus power unnecessarily, and are useful for high-level multimedia data coding, and more particularly, for video coding using variable block size based motion estimation.

The present invention is not limited to the above-described embodiments, and various variations and modifications may be possible without departing from the scope of the present invention.

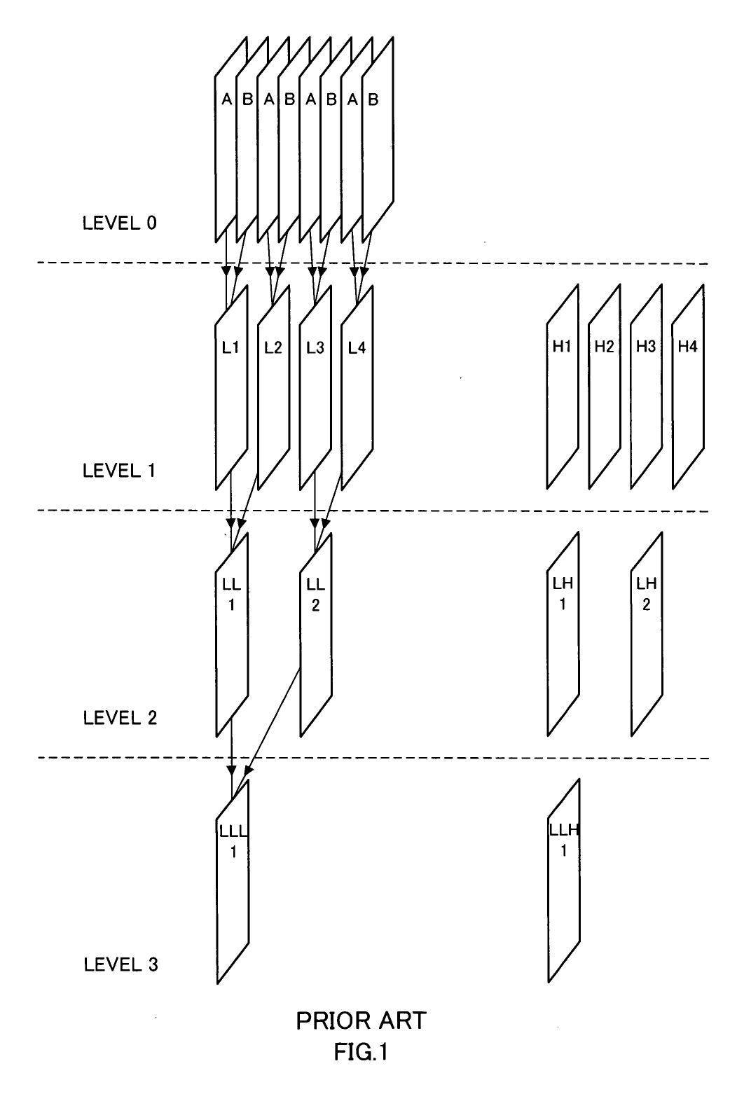

This application is based on Japanese Patent Application No. 2003-353989 filed on Oct. 14, 2003, the entire content of which is expressly incorporated by reference herein.

[FIG. 1]

LEVEL 0

LEVEL 1

LEVEL 2

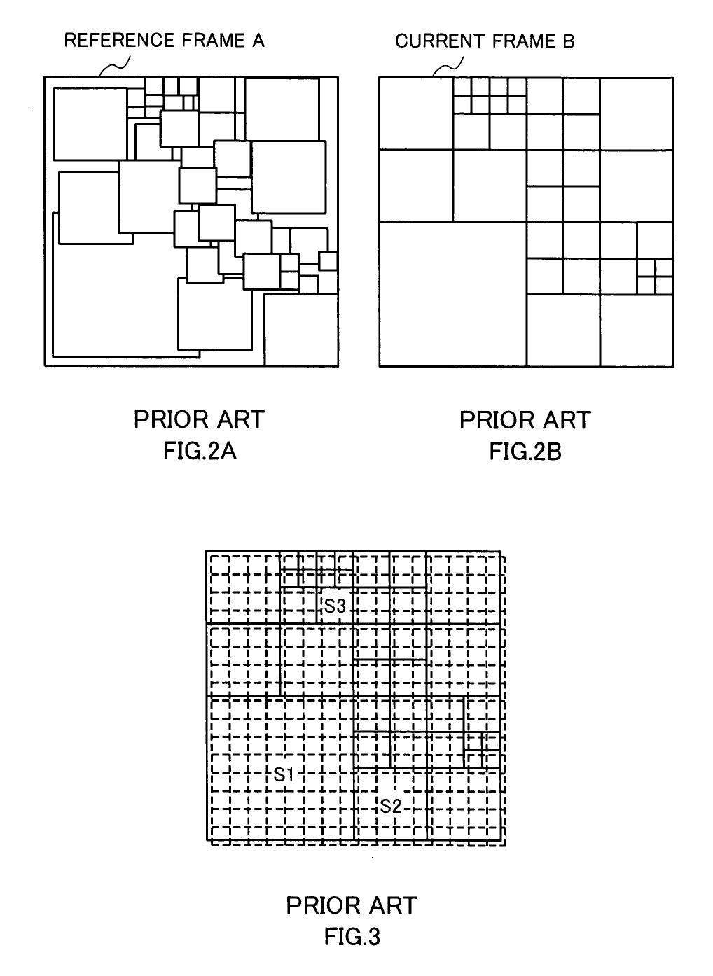

LEVEL 3

[FIG. 2B]

CURRENT FRAME B

[FIG. 2A]

REFERENCE FRAME A

[FIG. 4]

SEQUENCE
110 IMAGE INPUT SECTION
120 MOTION ESTIMATION SECTION
130 TEMPORAL FILTER
140 SPATIAL WAVELET DECOMPOSITION SECTION
150 SCANNING/ENTROPY CODING SECTION

STREAM
160 LOCAL DECODING SECTION
170 LOOP FILTER
180 REFERENCE FRAME BUFFER
   [FIG. 5]

START
ST1000 ME BLOCK ACQUISITION
ST1100 IS THERE A BOUNDARY?
ST1200 BOUNDARY INFORMATION ACQUISITION
ST1300 CODING/TRANSMISSION INFORMATION ACQUISITION
ST1400 TAP LENGTH SETTING
ST1500 FILTERING STRENGTH SETTING
ST1600 APPLICABLE PIXEL NUMBER SETTING
ST1700 FILTER ONE LINE OF PIXELS
ST1800 FILTERING FOR LAST LINE?
ST1900 PROCEED TO NEXT LINE
ST2000 IS THERE ANOTHER BOUNDARY?
ST2100 PROCEED TO NEXT BOUNDARY
ST2200 ALL ME BLOCKS FILTERED?
ST2300 PROCEED TO NEXT ME BLOCK

END

[FIG. 9]

LEVEL 0
DE-BLOCKING FILTERING

LEVEL 1
DE-BLOCKING FILTERING

LEVEL 2
DE-BLOCKING FILTERING

LEVEL 3

[FIG. 10]

STREAM
210 INVERSE SCANNING/INVERSE ENTROPY CODING SECTION
220 SPATIAL WAVELET COMPOSITION SECTION
230 TEMPORAL FILTER
240 MOTION COMPENSATION SECTION

RECONSTRUCTED FRAME
260 LOOP FILTER
270 REFERENCE FRAME BUFFER
   [FIG. 11]

STREAM
210 INVERSE SCANNING/INVERSE ENTROPY CODING SECTION
220 SPATIAL WAVELET COMPOSITION SECTION
230 TEMPORAL FILTER
240 MOTION COMPENSATION SECTION
270 REFERENCE FRAME BUFFER
310 POST FILTER

RECONSTRUCTED FRAME

1. A de-blocking filter processing apparatus comprising:
an acquisition section that acquires a variable-size motion estimation block in a frame for which motion estimation processing is performed; and
an application section that applies de-blocking filter processing to said frame in accordance with the acquired motion estimation block.

2. The de-blocking filter processing apparatus according to claim 1, wherein said application section performs de-blocking filter processing only at a boundary between a motion estimation block in said frame and another motion estimation block adjacent to that motion estimation block.

3. The de-blocking filter processing apparatus according to claim 2, wherein said application section sets a tap length of de-blocking filter processing for said frame based on at least one of coding information and transmission information for said frame.

4. The de-blocking filter processing apparatus according to claim 2, wherein said application section sets strength of de-blocking filter processing for said frame based on at least one of coding information and transmission information for said frame.

5. The de-blocking filter processing apparatus according to claim 2, wherein said application section sets a number of target pixels for de-blocking filter processing for said frame based on at least one of coding information and transmission information for said frame.

6. A video coding apparatus that has the de-blocking filter processing apparatus according to claim 2.

7. A video decoding apparatus that has the de-blocking filter processing apparatus according to claim 2.

8. The video decoding apparatus according to claim 7, wherein a temporal decomposition level at which de-blocking filter processing should be applied in said frame is changed in accordance with a signal transmitted from a corresponding video coding apparatus.

9. The video decoding apparatus according to claim 7, wherein application of de-blocking filter processing is performed when said frame is reconstructed.

10. A de-blocking filter processing method comprising:
an acquisition step of acquiring a variable-size motion estimation block in a frame for which motion estimation processing is performed; and
an application step of applying de-blocking filter processing to said frame in accordance with the acquired motion estimation block.
